(19) United States
(12) Patent Application Publication
(10) Pub. No.: US 2025/0303965 A1
(43) Pub. Date: Oct. 2, 2025

(54) VISUAL ASSISTANCE DISPLAY APPARATUS, VISUAL ASSISTANCE DISPLAY SYSTEM, AND VISUAL ASSISTANCE DISPLAY METHOD

(71) Applicant: KOITO MANUFACTURING CO., LTD., Tokyo (JP)

(72) Inventor: Koji HORIBE, Shizuoka (JP)

(21) Appl. No.: 19/235,576

(22) Filed: Jun. 12, 2025

Related U.S. Application Data
(63) Continuation of application No. PCT/JP2023/043385, filed on Dec. 5, 2023.

(30) Foreign Application Priority Data
Dec. 14, 2022 (JP) 2022-199394

(51) Int. Cl. B60R 1/27

(52) U.S. Cl. CPC B60R 1/27; B60R 2300/105; B60R 2300/301; B60R 2300/308

(57) ABSTRACT

A visual assistance display apparatus includes: a detection unit that detects an object; and a control unit that causes a display device to display a potential object that is undetectable by the detector in a manner that is superimposed on a real surrounding image. The control unit causes the display device to display an image that notifies the potential object in association with an object that obstructs a view of the potential object.

### CROSS REFERENCE TO RELATED APPLICATIONS

This application is a continuation application of International Patent Application No. PCT/JP2023/043385, filed on Dec. 5, 2023, which claims priority from Japanese Patent Application No. 2022-199394, filed on Dec. 14, 2022, with the Japan Patent Office, the disclosures of which are incorporated herein in their entireties by reference.

### TECHNICAL FIELD

The present disclosure relates to a visual assistance display apparatus, a visual assistance display system, and a visual assistance display method.

### BACKGROUND

In the related art, as a technique for assisting the visual field of the vehicle driver, for example, a technique is known in which a real image captured by an in-vehicle camera is combined with environmental information around a vehicle, such as symbolized other vehicles and obstacles, and the combined image is displayed on an in-vehicle monitor. Further, there is known a technique for superimposing and displaying information such as road surface information or navigation information, which has been processed to be easily recognizable by the driver, on a head-up display (HUD) mounted in a vehicle. As an example of a visual assistance display apparatus, Japanese Patent Laid-Open Publication No. 2012-056509 discloses a visual assistance device for a vehicle, in which a pop-up nozzle protrudes toward a forward direction of a vehicle body before reaching an intersection, a camera captures images of both the left and right regions of the intersection, and a monitor in the vehicle cabin displays the camera images to notify the driver of the presence of other vehicles or pedestrians on the intersection in an early stage.

### SUMMARY

It is important for the vehicle driver to quickly obtain information about people, other vehicles, obstacles, and others (hereinafter referred to as “objects”), and various approaches have conventionally been studied. The main conventional technique involves a configuration in which an object detection tool is provided in a vehicle and a detected surrounding object is displayed, for example, on a display tool mounted in the vehicle to notify the driver. However, in situations where many people, vehicles, and others are present, and traffic is congested and complex, there may be a case where information about objects detected solely by the object detection tool of the host vehicle is insufficient. That is, it is possible to avoid potential hazards in advance when the driver is able to recognize objects that may not be detected by the object detection tool of the host vehicle but are expected to approach or interact with the vehicle.

Therefore, the present disclosure has been made in consideration of the above-described conventional issues and provides a visual assistance display apparatus, visual assistance display system, and visual assistance display method capable of acquiring and notifying the information about objects that may not be directly detected by an in-vehicle device.

In order to address the above issues, according to the present disclosure, a visual assistance display apparatus includes a detection unit that detects an object, and a control unit that causes a display device to display a potential object that is undetectable by the detection unit in a manner that is superimposed on a real surrounding image, in which the control unit causes the display device to display an image that notifies the driver of the potential object in association with an object that obstructs a view of the potential object.

In the visual assistance display apparatus of the present disclosure, the control unit may cause the display device to display an image that notifies the potential object, in association with an object that obstructs a view of the potential object, and may acquire and notify the driver of the information about an object that may not be directly detected by an in-vehicle device. This allows the driver to recognize the presence of the potential object that is expected to approach or interact with the vehicle, and it becomes possible to avoid a potential hazard.

Further, according to one aspect of the present disclosure, when displaying the potential object, the control unit causes the display device to display a marker indicating the potential object by visually penetrating the object that obstructs the view of the potential object.

Further, according to one aspect of the present disclosure, the control unit determines, as the potential object, an object that is included in public detection information obtained by a public detection device but is not included in the object detection information obtained by the detection unit.

Further, according to one aspect of the present disclosure, the visual assistance display apparatus further includes a processing unit that extracts the potential object, an image capturing unit that acquires the real image captured around the visual assistance display apparatus, a position information acquisition unit that acquires position information of the visual assistance display apparatus, a communication unit that acquires map information in a vicinity of a position based on the position information from a map information providing device and to acquire the public detection information from the public detection device, and the display device, in which the processing unit extracts the potential object using the position information, the map information, the detection information, and the public detection information.

Further, according to one aspect of the present disclosure, the detection unit and the public detection device are each a LiDAR (light detection and ranging) that forms a point cloud including a plurality of reflection points on an object by detection light, and the processing unit extracts the potential object based on differential data between first point cloud data obtained by combining the map information with the detection information, and second point cloud data obtained by combining the map information with the public detection information.

Further, according to one aspect of the present disclosure, the differential data includes a plurality of potential object candidates, each being a set of reflection points, and the processing unit extracts the potential object from the plurality of potential object candidates by applying at least one of a first criterion for selecting the plurality of potential object candidates based on a shape and a second criterion for selecting the plurality of potential object candidates based on a movement state.

Further, according to one aspect of the present disclosure, the processing unit sets an undetectable region that is undetectable by the detection unit behind the object with the reflection points formed thereon, based on the first point cloud data, and extracts, as the potential object, a point cloud present within the undetectable region, from a point cloud included in the second point cloud data.

Further, according to one aspect of the present disclosure, the display is an eyeglass-type display device.

In order to address the above issues, according to the present disclosure, a visual assistance display system includes the visual assistance display apparatus, the map information providing device, and the public detection device.

In order to address the above issues, according to the present disclosure, a visual assistance display method includes providing a visual assistance display apparatus including a detection unit that detects an object, and a control unit that causes a display device to display a potential object that is undetectable by the detection unit in a manner that is superimposed on a real surrounding image; and causing the display device to display an image that notifies the driver of the potential object in association with an object that obstructs a view of the potential object.

According to the present disclosure, it is possible to provide a visual assistance display apparatus, visual assistance display system, and visual assistance display method capable of acquiring and notifying the driver of the information about objects that may not be directly detected by an in-vehicle device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1A is a top view illustrating an example of a vehicle equipped with a visual assistance display apparatus, and FIG. 1B is a side view illustrating an example of a public detection device, according to an embodiment.

FIG. 2 is a block diagram illustrating an example of a configuration of a visual assistance display apparatus, according to an embodiment.

FIG. 3A is a top view illustrating an example of map information, and FIG. 3B is a top view illustrating an example of a point cloud by a LiDAR installed on the host vehicle, according to an embodiment.

FIG. 4A is a top view illustrating an example of a point cloud by a LiDAR 52a installed on a signal pole 51a, and FIG. 4B is a top view illustrating an example of a point cloud by a LiDAR 52b installed on a signal pole 51b, according to an embodiment.

FIG. 5A is a top view illustrating a point cloud by combined public detection devices, and FIG. 5B is a top view illustrating a point cloud of a potential object candidate, according to an embodiment.

FIG. 6A is a top view illustrating a point cloud of a selected potential object candidate, and FIG. 6B is a top view illustrating a point cloud of a potential object, according to an embodiment.

FIG. 7A is a schematic diagram illustrating an example of a point cloud of people, and FIG. 7B is a schematic diagram illustrating an example of display on a monitor, in the visual assistance display apparatus according to an embodiment.

FIG. 8 is a flowchart illustrating an example of the processing flow of the visual field assistance display apparatus according to an embodiment.

FIGS. 9A and 9B are schematic diagrams illustrating an undetectable region, and FIG. 9C is a schematic diagram illustrating an example of a display image by smart glasses, according to an embodiment.

### DETAILED DESCRIPTION

In the following detailed description, reference is made to the accompanying drawings, which form a part thereof. The illustrative embodiments described in the detailed description, drawings, and claims are not meant to be limiting. Other embodiments may be utilized, and other changes may be made without departing from the spirit or scope of the subject matter presented here.

Hereinafter, embodiments of the present disclosure will be described with reference to the accompanying drawings. The same or equivalent components, elements, and processes illustrated in each drawing are denoted by the same reference numerals, and redundant descriptions are omitted as appropriate. In the following embodiments, a visual assistance display apparatus according to the present embodiment is described by way of example as being mounted on a mobile body such as a vehicle. Further, while the present embodiment assumes a conventionally driven vehicle operated by the driver, the present disclosure may also be applied to a vehicle equipped with an autonomous driving system or an advanced driver assistance system (ADAS).

The visual assistance display apparatus according to the present embodiment displays objects (hereinafter referred to as “potential objects”) that may not be detected by a detection tool mounted on the host vehicle. The potential objects may be any objects such as people, other vehicles, road signs, traffic signals, and other ground structures. In the present embodiment, people are described as an example of the potential objects. However, in this case, the term “people” includes, among others, individuals riding bicycles or operating kick scooters. Further, the visual assistance display apparatus according to the present embodiment may acquire detection information from public detection devices. The public detection devices according to the present embodiment refer to object detection tools installed to public structures such as signal poles, streetlights, utility poles, road signs, convex mirrors, and public buildings, which continuously detect objects around the public structures. In the present embodiment, an example of the public detection devices is described as detection tools installed to signal poles.

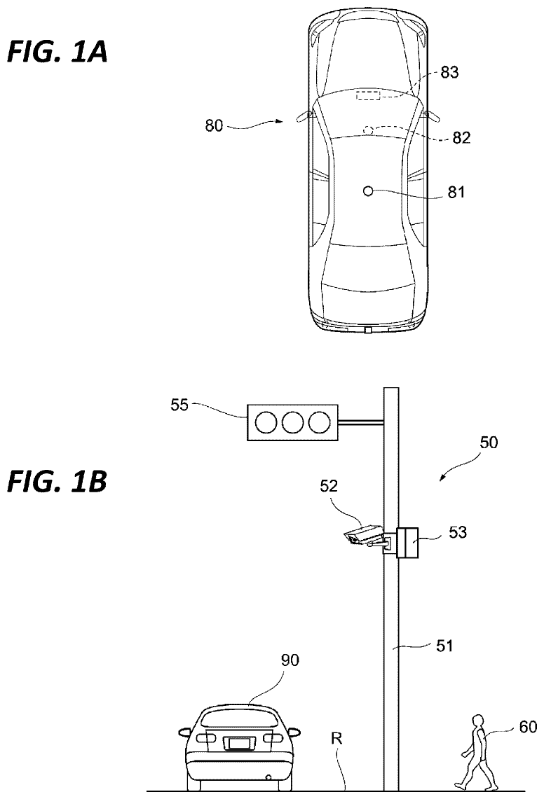

The visual assistance display apparatus, visual assistance display system, and visual assistance display method according to the present embodiment will be described with reference to FIGS. 1A to 9C. FIG. 1A is a top view illustrating an example of a vehicle equipped with the visual assistance display apparatus according to the present embodiment. As illustrated in FIG. 1A, a vehicle 80 according to the present embodiment includes a Light Detection And Ranging (LiDAR) 81 as a detector, a camera 82 (which may be a binocular or monocular camera) as an image capturing unit, and a monitor 83 as a display, which are components of the visual assistance display apparatus 10 (not illustrated). A detailed configuration of the visual assistance display apparatus 10 will be described in detail later.

The LiDAR 81 is a distance measurement device that irradiates an object with laser light and measures the time it takes for the reflected laser light to return from the object, thereby determining the distance and direction to the object. The LiDAR 81 may acquire information about the position, size, and others of the object. As illustrated in FIG. 1A, the LiDAR 81 of the visual assistance display apparatus 10 is, for example, mounted on the roof of the vehicle 80. However, the mounting position of the LiDAR 81 is not limited to the roof, and may be mounted at any appropriate position taking into consideration the scanning range and other factors. Here, the present embodiment describes a configuration using the LiDAR 81 as the distance measurement device by way of example, but is not limited thereto, and any other device such as a camera, ultrasonic sensor, or millimeter wave radar may also be used.

The camera 82 is an imaging device that captures an image of the front of the vehicle 80, and is mounted, for example, on the top of a front window of the vehicle 80, as illustrated in FIG. 1A. However, the mounting position is not limited to this, and the camera 82 may be mounted on the top of a rear window of the vehicle, in order to capture an image of the rear of the vehicle 80. The monitor 83 is, for example, a display device using a liquid crystal screen for displaying an image captured by the camera 82, an image representing a potential object, and other images. As illustrated in FIG. 1A, the monitor 83 is mounted, for example, near the driver's seat, at a position visible to the driver.

FIG. 1B is a side view illustrating a public detection device 50 equipped with a detection tool. As illustrated in FIG. 1B, the public detection device 50 includes a LiDAR 52 and a communication device 53, which are installed to a signal pole 51 with a traffic signal 55 thereon. The LiDAR 52 is a distance measurement device similar to the above-described LiDAR 81, and similarly, any other device such as a camera, ultrasonic sensor, or millimeter wave radar may also be used. The communication device 53 is used to connect the LiDAR 52 to a communication network such as an IP network. The LiDAR 52 continuously detects objects such as a person 60 and a vehicle 90 on a road surface R, and transmits detected information either continuously or intermittently to the surroundings via the communication device 53. The vehicle 80 may acquire the information from the LiDAR 52 through an in-vehicle communication unit (described later). The information from the LiDAR 52 includes point cloud data, which will be described later, and may also include the position (latitude and longitude), speed, movement direction, and others of an object as necessary. In addition, the position information of the public detection device 50 itself may be included in an HD map provided by a map information providing device, which will be described later. However, the storage of information is not limited to this, and the position information may be stored in a storage medium such as a ROM provided in the communication device 53, and may be transmitted to the vehicle 80 during communication.

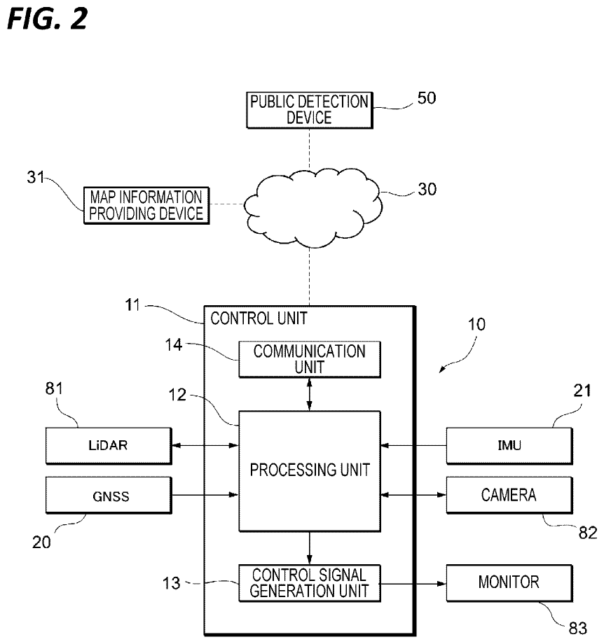

An example of a configuration of the visual assistance display apparatus 10 will be described with reference to FIG. 2. As illustrated in FIG. 2, the visual assistance display apparatus 10 includes a control unit 11, the LiDAR 81, a global navigation satellite system (GNSS) 20 as a position information acquirer, an inertial measurement unit (IMU) 21 as a driving information acquirer, the camera 82, and the monitor 83. The LiDAR 81, GNSS 20, IMU 21, camera 82, and monitor 83 are each connected to the control unit 11. The control unit 11 includes a processing unit 12, a control signal generating unit 13, and a communication unit 14.

The control unit 11 controls the processing unit 12, control signal generating unit 13, communication unit 14, LiDAR 81, GNSS 20, IMU 21, camera 82, and monitor 83. The control unit 11 may be, for example, a microcomputer including a CPU, ROM, RAM, and other components (not illustrated).

The GNSS 20 is a global navigation satellite system developed to assist in navigation for aircraft, ships, and other vehicles. This system is composed of a GPS satellite orbiting in space, a control station that tracks and manages the GPS satellite, and a user receiver for performing navigation. In other words, the GNSS 20 according to the present embodiment is a receiver for receiving information from the global navigation satellite system. The driver of the vehicle 80 may acquire information such as the latitude and longitude of the host vehicle by using the GNSS 20. In addition, since the purpose of the GNSS 20 is to acquire the position of the host vehicle, any other tool capable of determining the vehicle's position may also be used.

The IMU 21 is an inertial measurement unit that detects three-axes angles (or angular velocities) and accelerations that govern motion. The driver of the vehicle 80 may acquire the movement direction, speed, and others of the host vehicle (hereinafter, sometimes referred to as “driving information”) by using the IMU 21. In addition, since the purpose of the IMU 21 is to acquire driving information of the host vehicle, any other tool capable of detecting driving information may also be used.

The processing unit 12 is a component that processes the information acquired from the LiDAR 81, GNSS 20, IMU 21, and camera 82. The processing unit 12 may also store the position information acquired from the GNSS 20 and the driving information acquired from the IMU 21 in a storage medium such as an HDD (not illustrated).

The processing unit 12 acquires, as point cloud data, data of reflected light that is reflected from the surface of an object around the vehicle 80 as a result of the scanning of laser light (hereinafter, sometimes referred to as “detection light”) by the LiDAR 81. In other words, the term “point cloud data” according to the present embodiment refers to a set of reflection points on the object formed by detection light from the LiDAR 81. Further, the processing unit 12 acquires data indicating the distance from the LiDAR 81 to the object and the direction of the object as necessary. The processing unit 12 groups the point cloud data according to a predetermined rule to sort the point cloud data for each object. The processing unit 12 further identifies the type of each potential object from the sorted point cloud data for each object. The processing unit 12 converts the identified potential object (e.g., a person) into a marker as necessary.

The processing unit 12 notifies the driver of the presence of the identified potential object by a predetermined method. Details of the notification method will be described later, but as an example, an image of the surroundings of the vehicle 80 (hereinafter, sometimes referred to as “real image”) captured by the camera 82 is acquired, and the marked potential object as described above is displayed at a position in the real image where the potential object exists. In other words, the real image is combined with an image of the potential object. The control signal generating unit 13 generates a control signal to display the combined real image and potential object image (hereinafter, sometimes referred to as a “composite environmental image”) on the monitor 83, and sends the control signal to the monitor 83. The driver of the vehicle 80 may recognize the potential object such as a person by viewing the composite environmental image.

The communication unit 14 is connected to a communication network 30 such as an IP network, and acquires information from the public detection device 50, a map information providing device 31, and others. The communication device 53 of the public detection device 50 is connected to the communication network 30, and may be connected to the communication unit 14 of the visual assistance display apparatus 10 via the communication network 30. The map information providing device 31 provides an HD map. The map information providing device 31 is, for example, a server that stores the HD map. The HD map refers to high-precision three-dimensional map data, which is used in an autonomous driving system or an advanced driver assistance system (ADAS) to realize accurate self-position recognition and to refer to information about ground structures such as traffic signals. As described above, the HD map may also include the position information of the public detection device 50. The visual assistance display apparatus 10, public detection device 50, and map information providing device 31 constitute a visual assistance display system according to the present disclosure. In addition, in the present embodiment, the processing unit 12, the control signal generating unit 13, and the communication unit 14 are each realized by software, but are not limited thereto, and at least some of them may be realized by hardware such as an ASIC.

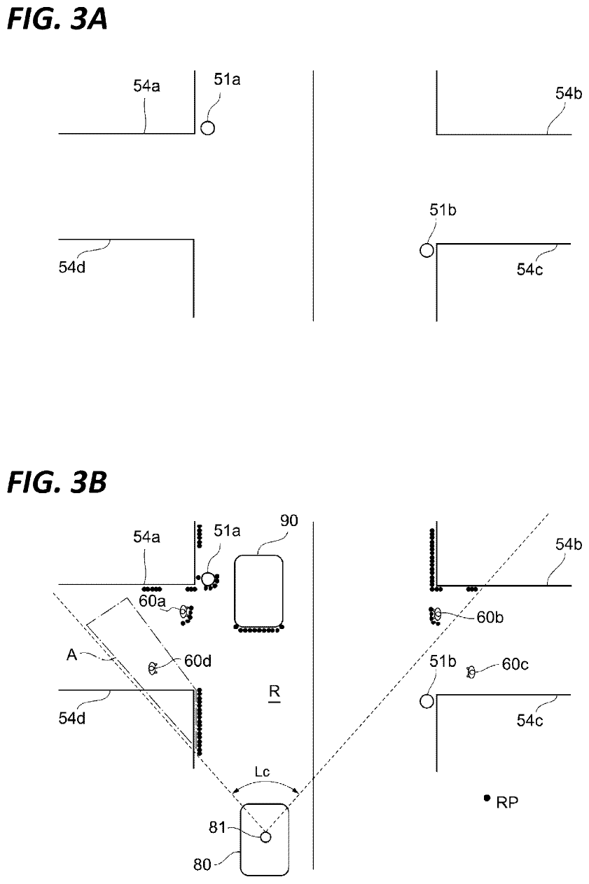

The operation of the visual assistance display apparatus 10 according to the present embodiment will be described in more detail with reference to FIGS. 3A to 8. FIG. 3A illustrates the arrangement of structures and others around the host vehicle 80, acquired from the HD map of the map information providing device 31. As illustrated in FIG. 3A, in the present embodiment, buildings 54a, 54b, 54c and 54d and signal poles 51a and 51b, which are arranged around the road surface R, are present around the vehicle 80. FIG. 3B illustrates point cloud data by the LiDAR 81 of the vehicle 80 as detection information. The point cloud data is an example of “first point cloud data” according to the present disclosure. In addition to the buildings 54a, 54b, 54c and 54d and signal poles 51a and 51b, there are also another vehicle 90 and persons 60a, 60b, 60c and 60d around the vehicle 80. The LiDAR 81 according to the present embodiment scans the front of the vehicle using a detection light beam Lc. The detection light beam Lc refers to a set of detection light within the scanning range of the LiDAR 81. FIG. 3B also illustrates an undetectable region A, which will be described later.

As described above, the detection light from the LiDAR 81 forms a reflection point RP on an irradiated portion of the object. In FIG. 3B, the reflection point is represented by a black dot. A point cloud refers to a set of reflection points RP that are considered to belong to the same object. For example, five reflection points are present on the person 60a, and these five reflection points constitute a point cloud. In addition, the point cloud illustrated in FIG. 3B is conceptually illustrated for the purpose of description, and the actual number of reflection points in a point cloud may be more or less than those illustrated in FIG. 3B. Further, in the present embodiment, the scanning range of the LiDAR 81 is limited to the front of the vehicle, but it is not limited thereto, and the scanning range may be limited to the rear, or may cover all directions. As illustrated in FIG. 3B, point clouds are formed on the buildings 54a, 54b and 54d, the signal pole 51a, the vehicle 90, and the persons 60a and 60b through the scanning of the LiDAR 81.

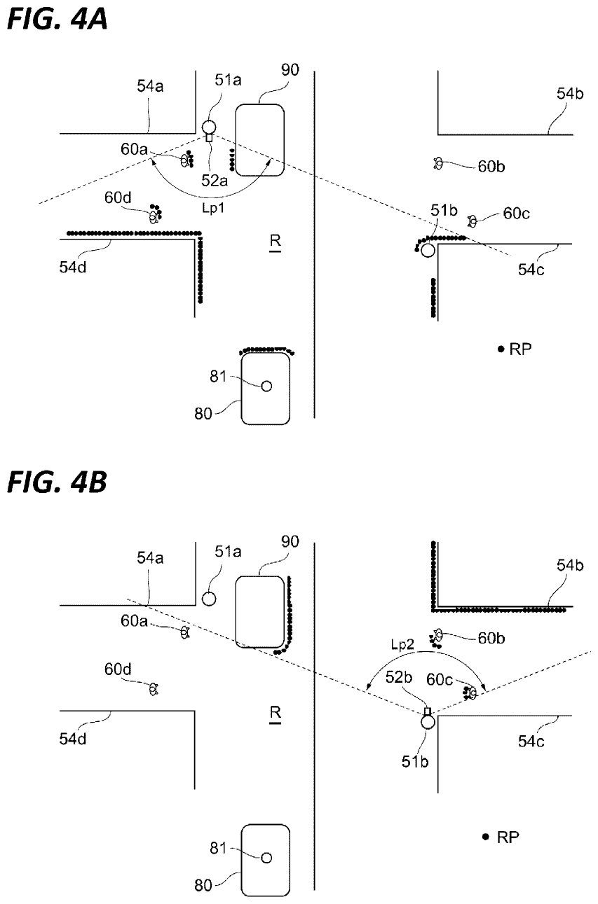

FIG. 4A illustrates point cloud data by the LiDAR 52a installed to the signal pole 51a. The LiDAR 52a performs scanning using a detection light beam Lp1. As a result, point clouds are formed on the buildings 54c and 54d, the signal pole 51b, the vehicle 90, the people 60a and 60d, and the vehicle 80. In addition, in the present embodiment, the scanning range of the LiDAR 52a is partially limited, but is not limited thereto, and the scanning range may be set, for example, to cover all directions.

FIG. 4B illustrates point cloud data by the LiDAR 52b installed to the signal pole 51b. The LiDAR 52b performs scanning using a detection light beam Lp2. As a result, point clouds are formed on the building 54b, the vehicle 90, and the persons 60b and 60c. In addition, in the present embodiment, the scanning range of the LiDAR 52b is partially limited, but is not limited thereto, and the scanning range may be set, for example, to cover all directions.

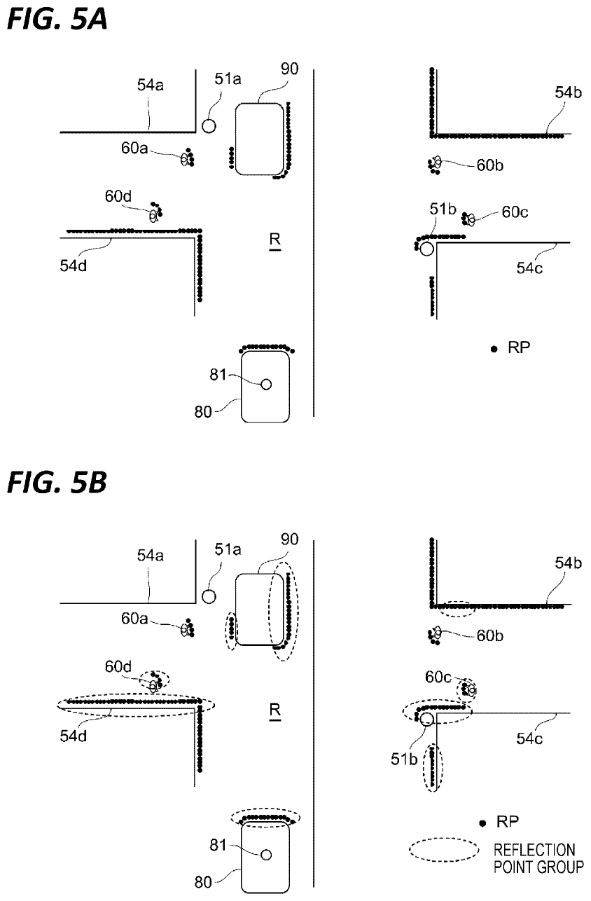

FIG. 5A illustrates point cloud data by the LiDAR 52a installed to the signal pole 51a, i.e., the data illustrated in FIG. 4A, combined with point cloud data by the LiDAR 52b installed to the signal pole 51b, i.e., the data illustrated in FIG. 4B. In other words, FIG. 5A illustrates point cloud data by public detection devices including the LiDARs 52a and 52b. The point cloud data is an example of “second point cloud data” according to the present disclosure. In addition, information by the public detection device is referred to as “public detection information.”

FIG. 5B illustrates reflection points RP that are included in the public detection information obtained from the public detection devices including the LiDARs 52a and 52b, but are not included in the detection information from the LiDAR 81 of the vehicle 80, i.e., the differential data between FIG. 3B and FIG. 5A. Sets of reflection points encircled with ellipses in FIG. 5B represent the difference, and in the present embodiment, the set of reflection points enclosed in each ellipse is referred to as “reflection point group.” That is, nine reflection point groups are present in FIG. 5B. Here, considering the possibility that a part of the point group may be missing when calculating the difference, the term “reflection point group RG” will be used instead of “point group” in the following description. Each reflection point group RG constitutes a potential object candidate in the sense that it may represent a potential object.

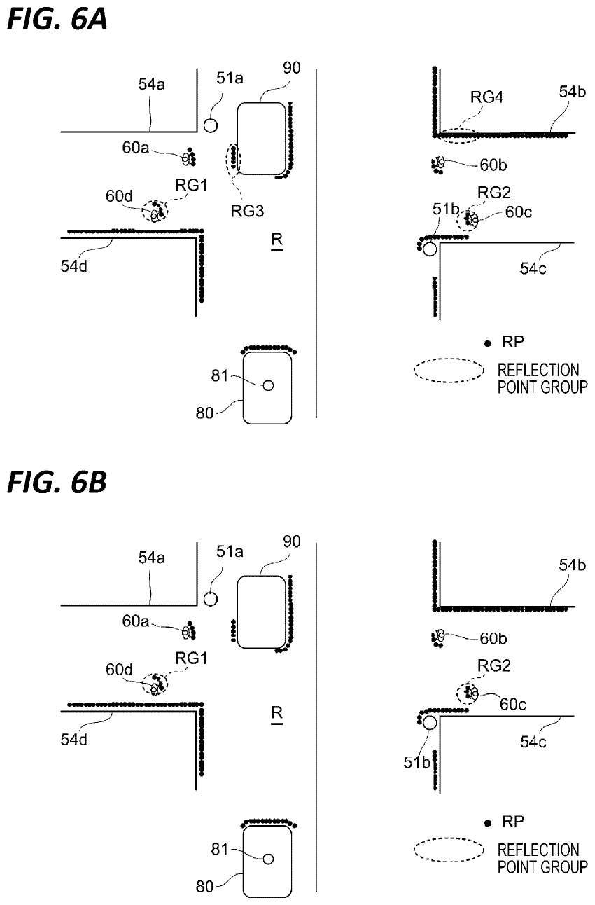

FIG. 6A illustrates the result of extracting a reflection point group RG that satisfies a predefined first criterion. The first criterion is a shape-based criterion used to move the reflection point group RG. In the present embodiment, since people and similar ones are assumed to be potential objects, the criterion is defined such that the length of the reflection point group is 1 m or less. In FIG. 6A, the nine reflection point groups are narrowed down to four reflection point groups RG1, RG2, RG3 and RG4 based on the first criterion. That is, the number of potential object candidates is reduced to four.

FIG. 6B illustrates finally extracted reflection point groups RG1 and RG2. In the present embodiment, when extracting a reflection point group corresponding to a potential object from among reflection point groups corresponding to potential object candidates, a predefined second criterion is applied. The second criterion is based on a movement state and specifies that the reflection point group moves. Whether or not the reflection point group RG moves is determined by comparing group positions across LiDAR scan frames. Here, a frame refers to point cloud data acquired during one scan cycle of the LiDAR. In other words, LiDAR scanning is updated on a per frame basis. For example, point cloud data acquired during one scan cycle of the LiDAR 81 using the detection light beam Lc as illustrated in FIG. 3B corresponds to one frame. The result of applying the second criterion to the state illustrated in FIG. 6A is illustrated in FIG. 6B. That is, the reflection point groups RG1 and RG2 are finally extracted. Since the reflection point groups RG1 and RG2 correspond to the persons 60d and 60c, respectively, it can be concluded that the persons 60d and 60c have finally been extracted as potential objects. In addition, in FIG. 6A, the reflection point group RG3 may also move. However, since the vehicle 90 is likely to exhibit a significant change in size during movement, it is considered to be excluded by the first criterion when comparing between frames.

In addition, In the present embodiment, the reflection point groups RG corresponding to potential object candidates were narrowed down based on the size of the object by applying the first criterion, but it is also acceptable not to apply this criterion and instead apply the second criterion to the reflection point groups RG illustrated in FIG. 5B, selecting those that are in motion as the reflection point groups corresponding to potential objects. Furthermore, people may be identified as potential objects based on the shape characteristics of the reflection point groups RG.

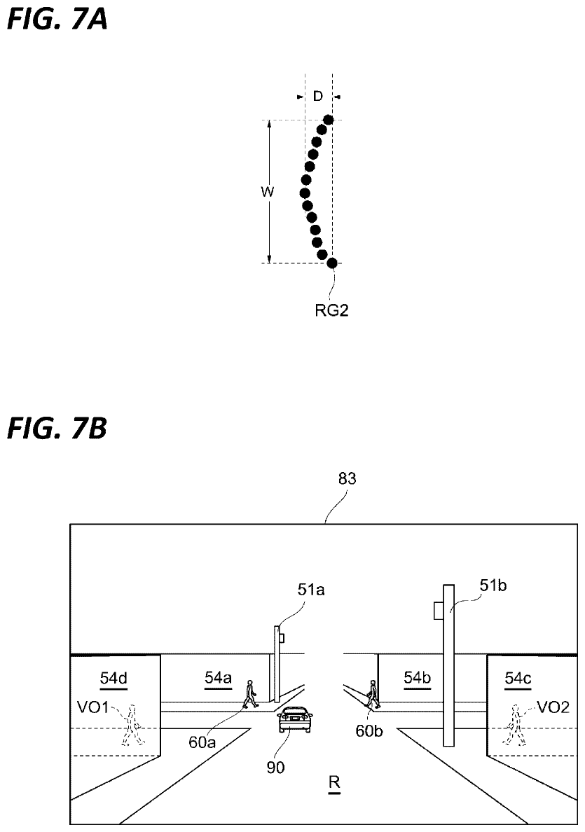

A method for identifying the reflection point group RG corresponding to the potential object when the potential object is a person will be described with reference to FIG. 7A. FIG. 7A illustrates the extracted reflection point group RG2 corresponding to the person 60c as illustrated in FIG. 6B. However, for the convenience of description, a greater number of reflection points RP is illustrated than in the actual case. In FIG. 7A, the width W and depth D (hereinafter, sometimes referred to as “feature values”) of the reflection point group RG2 are also illustrated. In the present embodiment, the feature values expected for the person 60 are stored in a storage medium such as an HDD (not illustrated). The specific values of the width W and depth D are, for example, approximately 50 cm to 100 cm for the width W and 30 cm to 60 cm for the depth D. The processing unit 12 determines that the reflection point group RG corresponds to the person 60 when the feature values fall within a pre-registered range. The feature values are not limited to the width W and the depth D and may also be appropriately determined taking into consideration factors such as the irradiation pattern of detection light. For example, the width W may suffice. When there are multiple potential objects including various types such as individuals riding bicycles or operating kick scooters, feature values are defined on a per potential object basis and are stored in a storage medium. According to this identification method, it is possible to identify a person as a potential object even when the person is stationary.

Next, a form of notifying the driver of the presence of a potential object will be described. In the present embodiment, the notification form is not particularly limited, but may include the following:
Displaying a marker indicating a potential object by visually penetrating an object (hereinafter, sometimes referred to as “obstructing object”) that obstructs the driver's view of the potential object;
Adding an alert marker (e.g., an exclamation mark) to the obstructing object;
Adding a leader line to the obstructing object and placing an alert marker (e.g., an exclamation mark) at the end of the leader line;
Indicating the obstructing object with an arrow; and
Making the obstructing object itself blink.

In short, in the present embodiment, an image indicating a potential object may be displayed on the monitor 83 in association with the obstructing object.

An example of the notification form will be described with reference to FIG. 7B. FIG. 7B is a diagram illustrating a form in which an image indicating a potential object is displayed by visually penetrating the obstructing object, among the notification forms described above. FIG. 7B illustrates an example of a display image on the monitor 83 provided in the vehicle 80, which is the host vehicle. The image of FIG. 7B is based on a real image of the front view captured by the camera 82 of the vehicle 80 at the position illustrated in FIG. 3B. The visual assistance display apparatus 10 according to the present embodiment superimposes and displays the potential objects corresponding to the reflection point groups RG1 and RG2, which were extracted earlier, on this real image. At this time, the processing unit 12 converts the reflection point groups RG1 and RG2 into easily recognizable markers for the driver. These markers converted from the reflection point groups RG1 and RG2 representing the potential objects are referred to as virtual objects. In FIG. 7B, the virtual object based on the reflection point group RG1 is designated by reference sign VO1, and the virtual object based on the reflection point group RG2 is designated by reference sign VO2. As described above, the virtual object VO1 corresponds to the person 60d, and the virtual object VO2 corresponds to the person 60c.

When displaying the virtual objects VO1 and VO2, the processing unit 12 also displays a virtual space necessary for grasping the positions of the virtual objects VO1 and VO2, such as the road surface R on which the virtual objects VO1 and VO2 may walk, as necessary. That is, a portion that does not appear in the image captured by the camera 82 is also displayed along with a perspective image (i.e., an image obtained by visually penetrating the obstructing object). The portion that does not appear in the real image captured by the camera 82 is created, for example, by comparing the HD map with the real image. The image obtained as a result of the above processing is a composite environmental image. According to the composite environmental image, the driver of the vehicle 80 may easily and accurately recognize potential objects such as people that may not be directly detected by the LiDAR 81. Furthermore, since the camera 82 may be set to a high sensitivity, it is particularly effective in recognizing pedestrians or others hidden in the shadows of buildings at night. In addition, in the present embodiment, the display form of superimposing the virtual objects VO1 and VO2 on the real image captured by the camera 82 has been exemplified, but the display form is not limited to this. For example, the virtual objects VO1 and VO2 may also be superimposed and displayed on the top view illustrated in FIG. 3A.

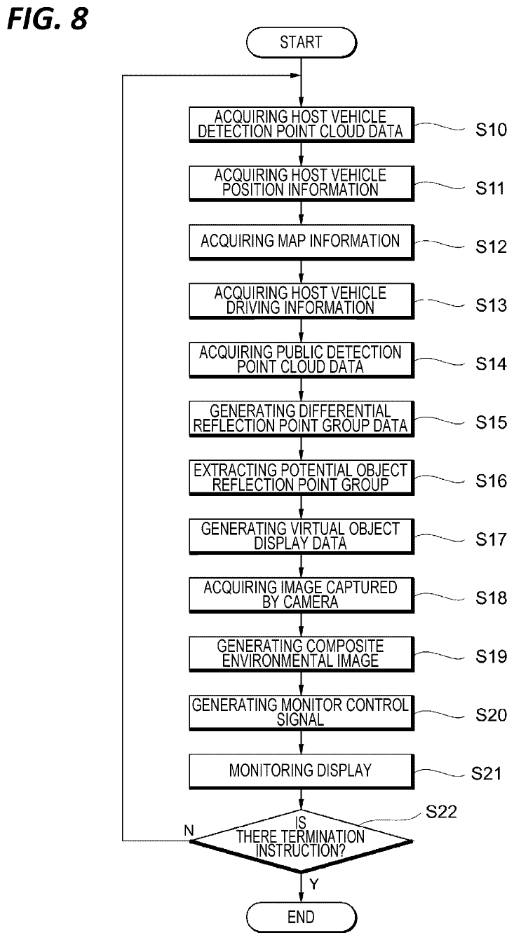

Display processing executed by the visual assistance display apparatus 10 according to the present embodiment will be described with reference to FIG. 8. FIG. 8 is a flowchart illustrating the processing flow of a display program that performs this display processing. As an example, the display program is stored in a storage medium such as a ROM (not illustrated), read by a CPU, and loaded in a RAM for execution.

In the following description, it is assumed that an execution start instruction for the display program has already been issued to the visual assistance display apparatus 10. The execution start instruction may be given, for example, when the control unit 11 receives the start of the engine of the vehicle 80. The processing unit 12 of the control unit 11 continuously or intermittently acquires point cloud data from the LiDAR 81 and captured images from the camera 82. The communication unit 14 of the control unit 11 continuously or intermittently acquires point cloud data from the LiDAR 52 of the public detection device 50.

Referring to FIG. 8, in step S10, the control unit 11 controls the processing unit 12 to acquire point cloud data detected by the LiDAR 81 of the vehicle 80, which is the host vehicle.

In step S11, the control unit 11 controls the processing unit 12 to acquire position information of the vehicle 80, which is the host vehicle, from the GNSS 20. In the present embodiment, the latitude and longitude of the vehicle 80 are acquired as an example of the position information.

In step S12, the control unit 11 controls the communication unit 14 to acquire map information. The communication unit 14 accesses the map information providing device 31 via the communication network 30 and acquires map information (HD map) for a predetermined range based on the latitude and longitude acquired in step S11. At this time, information such as the positions of the signal poles 51a and 51b is also acquired.

In step S13, the control unit 11 controls the processing unit 12 to acquire driving information of the vehicle 80, which is the host vehicle, from the IMU 21. In the present embodiment, as an example of the driving information, the movement direction, speed, and others of the vehicle 80 are acquired. The driving information such as the movement direction, speed, and others is used as necessary for purposes such as determining whether the vehicle is approaching a potential object.

In step S14, the control unit 11 controls the communication unit 14 to acquire point cloud data as public detection information from the public detection device 50. The communication unit 14 accesses the communication device 53a of the signal pole 51a and the communication device 53b of the signal pole 51b via the communication network 30, and acquires point cloud data from the LiDARs 52a and 52b. The point cloud data acquired in this step corresponds to the point cloud data illustrated in FIG. 5A.

In step S15, the control unit 11 controls the processing unit 12 to generate differential reflection point group data based on the difference between the point cloud data acquired in step S10 and the point cloud data acquired in step S14. An example of the differential reflection point group data generated in this step is illustrated in FIG. 5B.

In step S16, the control unit 11 controls the processing unit 12 to extract a reflection point group corresponding to a potential object. As described above, in the present embodiment, the above-described first and second criteria are applied to the data illustrated in FIG. 5B, which was generated in step S15, to extract the reflection point groups RG1 and RG2 corresponding to potential objects as illustrated in FIG. 6B.

In step S17, the control unit 11 generates data for displaying the reflection point group corresponding to the potential object as a virtual object. An example of the data generated in this step is data for displaying the virtual objects VO1 and VO2 as the above-described markers.

In step S18, the control unit 11 controls the processing unit 12 to acquire a captured image, i.e., a real image, from the camera 82.

In step S19, the control unit 11 controls the processing unit 12 to generate a composite environmental image. The composite environmental image is generated by superimposing the virtual objects VO1 and VO2 generated in step S17 on the real image acquired in step S18. An example of the composite environmental image is illustrated in FIG. 7B.

In step S20, the control unit 11 controls the control signal generating unit 13 to generate a control signal for displaying the composite environmental image generated in step S19 on the monitor 83.

In step S21, the control unit 11 controls the monitor 83 so that the composite environmental image is displayed on the monitor 83 based on the control signal generated in step S20.

In step S22, it is determined whether a termination instruction has been issued. When the determination is affirmative, the display program is terminated, and when the determination is negative, the processing returns to step S10 and continues acquiring point cloud data. The determination of whether the display program termination instruction has been issued may, for example, be based on the control unit 11 receiving information indicating that the engine of the vehicle 80 has been turned off by the driver.

Here, the surrounding environment of the vehicle 80, which is the host vehicle, typically changes from moment to moment. For example, since the persons 60d and 60c illustrated in FIG. 3B are moving, it is possible that a person identified as a potential object at a certain point in time may eventually become a regular object detectable by the LiDAR 81 as time passes. Even in such a case, in this display processing, a loop is continuously executed by returning to step S10 until a termination instruction is received after the processing has started, allowing reliable tracking of potential objects. In addition, the flowchart illustrated in FIG. 8 is merely an example, and the order of the steps may be changed or rearranged as long as it does not cause any inconsistency in the processing flow.

As described above in detail, according to the visual assistance display apparatus, visual assistance display system, and visual assistance display method of the present embodiment, it is possible to provide a visual assistance display apparatus, visual assistance display system, and visual assistance display method capable of acquiring and notifying of information about objects that may not be directly detected by an in-vehicle device.

In addition, in the present embodiment, the public detection device using the LiDAR was exemplified, but there may be a case where it is difficult to recognize a person, especially a stationary person, as a potential object using point cloud data from the LiDAR. In this case, by using a camera as the public detection device, it is possible to relatively easily determine a stationary person along with the position thereof by performing image recognition on an image captured by the camera.

Further, when many people are walking on the sidewalk, many potential objects may be extracted. In such a case, since virtual objects may become too numerous and complex, only a limited number (e.g., two or three) of virtual objects, such as those closest to the host vehicle 80, may be displayed. Even in such a case, since the display processing according to the present embodiment is looped as illustrated in FIG. 8, it may also accommodate updates such as replacement of potential objects.

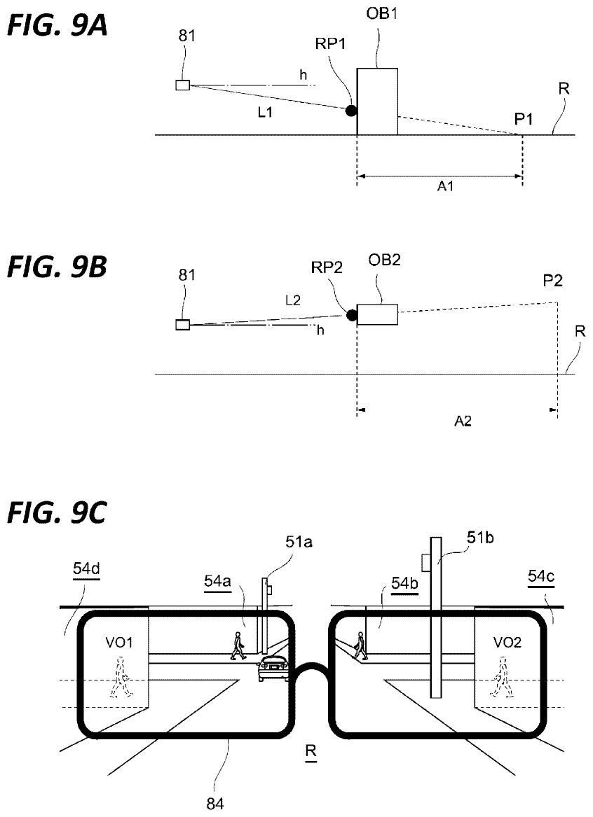

Here, two modifications of the visual assistance display apparatus, visual assistance display system, and visual assistance display method according to the present embodiment will be described with reference to FIGS. 9A to 9C. A first modification is a configuration in which, instead of using differential data between point cloud data by the LiDAR of the host vehicle and point cloud data by the LiDAR of the public detection device for extracting a potential object, an undetectable region of the LiDAR of the vehicle is used. In the present embodiment, a point cloud that exists within the undetectable region is extracted as a potential object. In the method described in the above embodiment, where the point cloud data difference is used, there is a possibility that a part of the point group may be missing when calculating the difference. In this case, there may be a case where a potential object is extracted based on a sparse point cloud, which could be susceptible to noise and other disturbances. This modification is effective in such a situation.

The undetectable region of the LiDAR 81 of the vehicle 80 will be described with reference to FIGS. 9A and 9B. In this modification, the LiDAR 81 performs scanning not only in the horizontal direction but also in the vertical direction. FIG. 9A illustrates an example in which scanning is performed downward in the vertical direction, with detection light L1 being emitted downward of the horizontal line h in the vertical direction. When an object OB1 is present in front of the LiDAR 81, a reflection point RP1 is formed on the object OB1 by the detection light L1, and the rear of the object OB1 on the opposite side of the LiDAR 81 may not be detected. When an intersection point between the extension line of the detection light L1 and the road surface R is designated by P1, the range from the object OB1 to the point P1 is defined as an undetectable region A1.

FIG. 9B illustrates an example in which scanning is performed upward in the vertical direction, with detection light L2 being emitted upward of the horizontal line h in the vertical direction. When an object OB2 is present in front of the LiDAR 81, a reflection point RP2 is formed on the object OB2 by the detection light L2, and the rear of the object OB2 on the opposite side of the LiDAR 81 may not be detected. When a point corresponding to the maximum detectable distance of the LiDAR 81 is designated by P2, the range from the object OB2 to the point P2 is defined as an undetectable region A2. The undetectable regions A1 and A2 are formed three-dimensionally around the LiDAR 81.

The undetectable regions A1 and A2 identified as described above are stored in a storage medium such as an HDD (not illustrated) and are used in the processing described below. Here, since the undetectable regions identified as described above are three-dimensional data and the undetectable region A2 particularly extends up to the maximum detectable distance of the LiDAR 81, there may be a case where data volume becomes large. In such a case, the vertical scanning angle of the LiDAR 81 may be fixed (i.e., vertical scanning is not performed), and a region up to a predetermined distance from the LiDAR 81 (hereinafter referred to as “maximum detection distance”) may be defined as an undetectable region. The maximum detection distance may be set as the greatest distance at which a potential object is assumed to pose an impact on the host vehicle from the perspective of traffic safety. By identifying the undetectable region in this way, the amount of data for the undetectable region may be reduced.

The identification of a potential object according to this modification will be described in more detail with reference to FIGS. 3B and 5A. For example, in FIG. 3B, since a point cloud is formed on the sidewall of the building 54d, the building 54d acts as an obstructing object. Thus, an undetectable region A is formed behind the point cloud on the opposite side of the vehicle 80. Naturally, no point cloud is formed for the person 60d present in the undetectable region A. On the other hand, it can be seen from FIG. 5A that the person 60d is present in the undetectable region A. Thus, the control unit 11 determines that the person 60d is a potential object. If necessary, the above-described first criterion or second criterion may be further applied. In addition, undetectable regions may also be formed respectively behind the buildings 54a and 54b illustrated in FIG. 3B, but detecting potential objects in the undetectable regions is not particularly meaningful since these regions are far from the vehicle 80. Thus, these regions may be excluded from the undetectable region by appropriately setting the aforementioned maximum detection distance. According to this modification, it is possible to more reliably extract a potential object.

A second modification will be described below with reference to FIG. 9C. This modification uses, as a display, smart glasses (eyeglass-type display device) instead of the monitor 83. Smart glasses are a type of wearable device, which is shaped like glasses, worn near the eyes like regular glasses. They function as a display capable of superimposing information onto the real scenery, and due to this function, they are sometimes referred to as augmented reality (AR) glasses. In the present embodiment, smart glasses are connected instead of the monitor 83 illustrated in FIG. 2, and the driver wears the smart glasses while driving. When an HUD is used, visibility involves a shift in the driver's line of sight. Further, when a head mounted display (HMD) is used, it may obstruct the field of view as the HMD covers the entire eyes. The smart glasses eliminate such drawbacks, thereby providing enhanced safety.

FIG. 9C illustrates an example of a display image in smart glasses 84. In the smart glasses, virtual objects VO1 and VO2 are superimposed on the real surrounding scenery. The driver may recognize where a potential object is located by viewing the real scenery and the virtual objects VO1 and VO2 through the smart glasses 84. Furthermore, since the driver may simultaneously view the scenery outside the smart glasses 84, which further enhances safety.

As described above in detail, according to the visual assistance display apparatus, visual assistance display system, and visual assistance display method of these modifications as well, it is possible to provide a visual assistance display apparatus, visual assistance display system, and visual assistance display method capable of acquiring and notifying of information about objects that may not be directly detected by an in-vehicle device. In particular, according to the first modification, potential objects may be extracted more reliably. Further, according to the second modification, the safety of viewing potential objects may be further enhanced.

From the foregoing, it will be understood that various examples of the present disclosure are described for illustrative purposes, and that various variations may be made without departing from the scope and idea of the present disclosure. Therefore, the various examples disclosed herein are not intended to limit the essential scope and ideas designated by each of the following claims.

What is claimed is:

1. A visual assistance display apparatus comprising:
a detector configured to detect an object; and
a controller configured to cause a display to display a potential object that is undetectable by the detector in a manner that is superimposed on a real surrounding image,
wherein the controller causes the display to display an image that notifies of the potential object in association with an object that obstructs a view of the potential object.

2. The visual assistance display apparatus according to claim 1, wherein when displaying the potential object, the controller causes the display to display a marker indicating the potential object by visually penetrating the object that obstructs the view of the potential object.

3. The visual assistance display apparatus according to claim 1, wherein the controller determines, as the potential object, an object that is included in public detection information obtained by a public information detector but is not included in object detection information obtained by the detector.

4. The visual assistance display apparatus according to claim 3, further comprising:
a processor configured to extract the potential object;
a camera configured to acquire the real image captured around the visual assistance display apparatus;
a position information navigator configured to acquire position information of the visual assistance display apparatus;
a communication interface configured to acquire map information in a vicinity of a position based on the position information from a map information providing server and to acquire the public detection information from the public information detector; and
the display,
wherein the processor extracts the potential object using the position information, the map information, the detection information, and the public detection information.

5. The visual assistance display apparatus according to claim 4, wherein the detector and the public detection device are each a LiDAR (light detection and ranging) configured to form a point cloud including a plurality of reflection points on an object by detection light, and
the processor extracts the potential object based on differential data between first point cloud data obtained by combining the map information with the detection information, and second point cloud data obtained by combining the map information with the public detection information.

6. The visual assistance display apparatus according to claim 5, wherein the differential data includes a plurality of potential object candidates, each being a set of reflection points, and
the processor extracts the potential object from the plurality of potential object candidates by applying at least one of a first criterion for selecting the plurality of potential object candidates based on a shape and a second criterion for selecting the plurality of potential object candidates based on a movement state.

7. The visual assistance display apparatus according to claim 5, wherein the processor sets an undetectable region that is undetectable by the detector behind the object with the reflection points formed thereon, based on the first point cloud data, and extracts, as the potential object, a point cloud present within the undetectable region, from a point cloud included in the second point cloud data.

8. The visual assistance display apparatus according to claim 1, wherein the display is an eyeglass-type display device.

9. A visual assistance display system comprising:
the visual assistance display apparatus according to claim 4;
the map information providing server; and
the public information detector.

10. A visual assistance display method comprising:
providing a visual assistance display apparatus including:
a detector configured to detect an object, and
a controller configured to cause a display to display a potential object that is undetectable by the detector in a manner superimposed on a real surrounding image; and
causing the display to display an image that notifies the potential object in association with an object that obstructs a view of the potential object.
